(19) United States
(12) Patent Application Publication
(10) Pub. No.: US 2026/0161448 A1
(43) Pub. Date: Jun. 11, 2026

(54) METHOD FOR MANAGING JOBS AND COMPUTING SYSTEM FOR PERFORMING THE SAME

(71) Applicant: REBELLIONS INC., Seongnam-si (KR)

(72) Inventors: Seokju YOON, Seongnam-si (KR); Sangwook PARK, Seongnam-si (KR); Hyunseok KO, Seongnam-si (KR); Sanghyun HAN, Seongnam-si (KR)

(21) Appl. No.: 19/408,255

(22) Filed: Dec. 3, 2025

(30) Foreign Application Priority Data
Dec. 6, 2024 (KR) 10-2024-0180851

(51) Int. Cl. G06F 9/48; G06F 11/07

(52) U.S. Cl. CPC G06F 9/4881; G06F 11/0721; G06F 11/0766; G06F 2209/481

(57) ABSTRACT

The present disclosure provides a method for managing jobs, performed by at least one processor. The method includes distributing a plurality of jobs associated with at least one context to a plurality of processing devices, storing a fully processed job among the distributed jobs in a job pending queue, identifying a first context associated with an error in response to determining that the error has occurred in at least one context, initializing each of a plurality of command queues included in the plurality of processing devices, determining a recovery target job based on the identified first context, and recovering the determined recovery target job to each of the plurality of initialized command queues. The plurality of processing devices include a plurality of command queues storing the distributed jobs.

### CROSS-REFERENCE TO RELATED APPLICATION

The present application claims priority to Korean Application No. 10-2024-0180851, filed on Dec. 6, 2024, in the Korean Intellectual Property Office, the entire disclosure of which is incorporated by reference herein.

### BACKGROUND

### Field

The present disclosure relates to a method for managing jobs and a computing system. Specifically, the present disclosure relates to a technology that identifies a context in which an error has occurred during operation in a multi-device environment, excludes the context from a service, and guarantees continuity of a job by recovering another context using a job pending queue in which a fully processed job is stored.

### Description of Related Art

In order to perform an artificial intelligence operation, hardware specialized for the artificial intelligence operation is being used. For example, the artificial intelligence operation is being performed faster using an accelerator including a graphic processing unit (GPU), a neural processing unit (NPU), and the like. Data serving as a basis for the artificial intelligence operation is transmitted to such hardware, and the hardware may provide an artificial intelligence operation result (e.g., an inference result) by applying the received data to a machine learning model.

Due to various causes such as an error in input data applied to the machine learning model, an error in a system or a chip, and the like, an error may occur during the artificial intelligence operation, and the artificial intelligence operation may fail. In preparation for a failure of the artificial intelligence operation, a system is being designed to partition hardware resources and independently perform each job through the partitioned hardware resources. For example, the system may be designed such that a cache, a random access memory (RAM), a sys pipe, and the like are separated in advance, and an independent job may be used through the separated hardware resources. In this case, independent artificial intelligence operation jobs are performed in each of the partitioned hardware resources, and even if an error occurs in a specific job, the error does not affect other jobs, so that fault tolerance may be satisfied.

As described above, partitioning the hardware resources incurs a high design cost, and additionally, may require many hardware resources. Accordingly, needs for a technology capable of satisfying the fault tolerance at a low cost are arising.

The above information is for improving understanding of the background of the present disclosure, and may include information that does not constitute the prior art.

### SUMMARY

The present disclosure provides a method for managing jobs, a computer program stored in a computer-readable recording medium, a computer-readable recording medium, and an apparatus (system) for solving the above problems.

The present disclosure may be implemented in various ways, including a computer program stored in a method, an apparatus (system), and/or a computer-readable storage medium.

According to an embodiment of the present disclosure, a method for managing jobs, performed by a host device, may include distributing a plurality of jobs associated with at least one context to a plurality of processing devices, storing a fully processed job among the distributed jobs in a job pending queue, identifying a first context associated with an error in response to determining that the error has occurred in at least one context, initializing each of a plurality of command queues included in the plurality of processing devices, determining a recovery target job based on the identified first context, and recovering the determined recovery target job to each of the plurality of initialized command queues. The plurality of processing devices may include a plurality of command queues storing the distributed jobs.

According to an embodiment of the present disclosure, the determining may include identifying, as a first recovery target job, a job other than the first context among jobs stored in the job pending queue, and determining, as a second recovery target job, a job other than the first context among jobs stored in each of the plurality of command queues.

According to an embodiment of the present disclosure, the recovering may include recovering the first recovery target job prior to recovering the second recovery target job, and sequentially recovering the second recovery target job to have an order subsequent to the first recovery target job.

According to an embodiment of the present disclosure, the job stored in the job pending queue includes node data associated with at least one processing device among the plurality of processing devices, and the recovering the first recovery target job may include transmitting the first recovery target job to a processing device associated with the first recovery target job based on the node data included in the first recovery target job.

According to an embodiment of the present disclosure, the method for managing jobs may further include, after the storing, identifying a fully processed second context among the at least one context, and deleting a job associated with the identified second context from the job pending queue.

According to an embodiment of the present disclosure, the second context includes a first job and a second job, and the identifying the fully processed second context may include determining whether the first job is fully processed, determining whether the second job is fully processed, and determining that the second context is fully processed in response to determining that the first job and the second job are fully processed.

According to an embodiment of the present disclosure, the identifying the second context may include identifying a number of jobs associated with the second context, counting a completion count of the jobs associated with the second context, and determining that the second context is fully processed in response to determining that the counted completion count is equal to the number of jobs.

According to an embodiment of the present disclosure, the method for managing jobs may further include, prior to the identifying the first context, receiving an error message from at least one processing device among the plurality of processing devices, and determining that the error has occurred in the at least one context in response to receiving the error message.

According to an embodiment of the present disclosure, the identifying the first context may include identifying a job in which the error has occurred based on the error message, and determining that the error has occurred in the first context in response to determining that the first context is associated with the job in which the error has occurred.

According to an embodiment of the present disclosure, the method for managing jobs may further include, prior to the identifying the first context, receiving a timeout report from at least one processing device among the plurality of processing devices, and determining that the error has occurred in the at least one context based on the timeout report.

According to an embodiment of the present disclosure, the identifying the first context may include identifying a number of jobs included in the first context, counting a reception count of the timeout report associated with the first context, and determining that the error has occurred in the first context in response to determining that the reception count is equal to the number of jobs.

According to an embodiment of the present disclosure, the storing in the job pending queue may include receiving a job completion report from at least one processing device among the plurality of processing devices, identifying a job associated with the job completion report in response to receiving the job completion report, processing the job associated with the job completion report as fully processed, and storing the fully processed job in the job pending queue.

According to an embodiment of the present disclosure, the storing in the job pending queue may include receiving a timeout report from at least one of the plurality of processing devices, identifying a job associated with the timeout report in response to receiving the timeout report, processing the job associated with the timeout report as fully processed, and storing the fully processed job in the job pending queue.

According to an embodiment of the present disclosure, the at least one context is associated with a specific user, and the method for managing jobs may further include identifying a context associated with the timeout report in response to receiving the timeout report, and transmitting the timeout report to a user associated with the identified context.

According to an embodiment of the present disclosure, the first context includes a third job and a fourth job, the third job includes a first command and a second command, the fourth job includes a third command and a fourth command, and at least one of the first command or the second command may be associated with at least one of the third command or the fourth command.

According to an embodiment of the present disclosure, a non-transitory computer-readable recording medium storing instructions that, when executed by a processor, cause the processor to perform any one of the above-mentioned methods may be provided.

According to an embodiment of the present disclosure, a computing system includes a job pending queue storing a fully processed job and at least one host processor configured to manage the job pending queue, and the at least one host processor may be further configured to distribute a plurality of jobs associated with at least one context to a plurality of processing devices, store a fully processed job among the distributed jobs in the job pending queue, identify a first context associated with an error in response to determining that the error has occurred in at least one context, initialize each of a plurality of command queues included in the plurality of processing devices, determine a recovery target job based on the identified first context, and recover the determined recovery target job to each of the plurality of initialized command queues. The plurality of processing devices may include a plurality of command queues storing the distributed jobs.

According to an embodiment of the present disclosure, the determining may include identifying, as a first recovery target job, a job other than the first context among jobs stored in the job pending queue, and determining, as a second recovery target job, a job other than the first context among jobs stored in each of the plurality of command queues.

According to an embodiment of the present disclosure, the recovering may include recovering the first recovery target job prior to recovering the second recovery target job, and sequentially recovering the second recovery target job to have an order subsequent to the first recovery target job.

According to an embodiment of the present disclosure, the at least one host processor may be further configured to identify a fully processed second context among the at least one context, and delete a job associated with the identified second context from the job pending queue.

According to various embodiments of the present disclosure, the host system configures the job pending queue storing the fully processed job, so that a job in a dependency relationship that is already fully processed may be normally recovered even in a queue initialization and recovery process. Through this, upon reset, although the dependency relationship is not resolved, deletion of the already fully processed job is prevented, and stability of the system and continuity of a job flow may be guaranteed.

According to various embodiments of the present disclosure, the host processor does not adopt a scheme of distributing jobs by considering all dependency relationships by configuring a separate queue before distributing the jobs, but after distributing a plurality of jobs having a dependency relationship to the plurality of processing devices, each device processor in the dependency relationship with each other may transmit and receive data to and from each other and execute a command. Through such a configuration, overhead of the host may be effectively reduced, and a dependency issues are processed in real time through dynamic interaction between devices, and bottlenecks that may occur in a job distribution process are prevented and a processing speed of the system may be improved.

According to various embodiments of the present disclosure, the host system may provide a quick response to timeout detection to a user terminal before identifying whether the error occurs. Through such a configuration, a user may quickly recognize a situation and perform a necessary countermeasure, and stability of the entire system is improved and user experience may be improved.

According to various embodiments of the present disclosure, fault tolerance for the error may be satisfied without needing to partition hardware resources.

The effects of the present disclosure are not limited to the effects mentioned above, and other effects not mentioned will be clearly understood by those skilled in the art (hereinafter referred to as “ordinary technician”) in the technical field to which the present disclosure belongs from the description of the claims.

### BRIEF DESCRIPTION OF THE DRAWINGS

Embodiments of the present disclosure will be described below with reference to the accompanying drawings described below, wherein like reference numerals indicate like elements, but are not limited thereto.

FIG. 1 is a block diagram illustrating a processing system according to some embodiments of the present disclosure.

FIG. 2 is a block diagram illustrating the processing device of FIG. 1 in detail.

FIG. 3 is a block diagram illustrating the host system of FIG. 1 in detail.

FIG. 4 is a block diagram illustrating a processing system according to some embodiments of the present disclosure.

FIG. 5 is a diagram illustrating a relationship between a host processor and a device processor according to an embodiment of the present disclosure.

FIG. 6 is a diagram illustrating an example of a command queue and a command buffer included in a processing device according to an embodiment of the present disclosure.

FIG. 7 is a diagram illustrating an example of a job pending queue included in a host system and a command buffer included in each processing device according to an embodiment of the present disclosure.

FIG. 8 is a diagram illustrating an example in which an error exists in an artificial intelligence operation associated with a first context according to an embodiment of the present disclosure.

FIG. 9 is a diagram illustrating a process in which a command queue is recovered after being initialized according to an embodiment of the present disclosure.

FIG. 10 is a diagram illustrating an example of a job pending queue included in a host system and a command buffer included in each processing device according to an embodiment of the present disclosure.

FIG. 11 is a diagram illustrating an example in which a timeout is detected according to an embodiment of the present disclosure.

FIG. 12 is a diagram illustrating a process in which a command queue is recovered after being initialized according to an embodiment of the present disclosure.

FIG. 13 is a flowchart illustrating a job management method according to an embodiment of the present disclosure.

FIG. 14 is a flowchart illustrating a job recovery method according to an embodiment of the present disclosure.

### DETAILED DESCRIPTION

Hereinafter, specific details for implementation of the present disclosure will be described in detail with reference to the accompanying drawings. However, in the following description, if there is a concern that the gist of the present disclosure may be unnecessarily obscured, a detailed description of widely known functions or configurations will be omitted.

In the accompanying drawings, the same or corresponding components are assigned the same reference numerals. In addition, in the description of the following embodiments, duplicate descriptions of the same or corresponding components may be omitted. However, even if a description of a component is omitted, it is not intended that such a component is not included in any embodiment.

Advantages and features of the disclosed embodiments, and methods for achieving them, will become apparent with reference to the embodiments described below in conjunction with the accompanying drawings. However, the present disclosure is not limited to the embodiments disclosed below, but may be implemented in various different forms, and only these embodiments are provided so that the present disclosure is complete and the scope of the invention is fully informed to those skilled in the art.

Terms used in this specification will be briefly described, and the disclosed embodiments will be described in detail. Although general terms currently widely used as possible were selected as the terms used in this specification while considering functions in the present disclosure, these may vary depending on the intention of a technician working in a related field, precedent, emergence of new technology, etc. In addition, in a specific case, there is a term arbitrarily selected by the applicant, and in this case, the meaning thereof will be described in detail in the description part of the corresponding invention. Therefore, the terms used in the present disclosure should be defined based on the meaning of the term and the contents throughout the present disclosure, rather than a simple name of the term.

Singular expressions in this specification include plural expressions unless the context clearly specifies them as singular. In addition, plural expressions include singular expressions unless the context clearly specifies them as plural. Throughout the specification, when a part includes a component, this means that it may further include other components, not excluding other components, unless specifically stated to the contrary.

In addition, the term “module” or “unit” used in the specification means a software or hardware component, and the “module” or “unit” performs certain roles. However, the “module” or “unit” is not limited to software or hardware. The “module” or “unit” may be configured to reside in an addressable storage medium or may be configured to reproduce one or more processors. Thus, as an example, the “module” or “unit” may include components such as software components, object-oriented software components, class components, and task components, and processes, functions, attributes, procedures, subroutines, segments of program code, drivers, firmware, microcode, circuitry, data, databases, data structures, tables, arrays, or variables. Functions provided within the components and the “modules” or “units” may be combined into a smaller number of components and “modules” or “units” or may be further separated into additional components and “modules” or “units”.

According to an embodiment of the present disclosure, the “module” or “unit” may be implemented as a processor and a memory, or may be implemented as a circuit or circuitry. Terms such as “circuit” and “circuitry” mean a circuit on hardware, but may also mean a circuit on software. The “processor” should be interpreted broadly to include a general-purpose processor, a central processing unit (CPU), a microprocessor, a digital signal processor (DSP), a controller, a microcontroller, a state machine, and the like. In some environments, the “processor” may refer to an application-specific integrated circuit (ASIC), a programmable logic device (PLD), a field programmable gate array (FPGA), and the like. The “processor” may refer to a combination of processing devices, such as, for example, a combination of a DSP and a microprocessor, a combination of a plurality of microprocessors, a combination of one or more microprocessors combined with a DSP core, or a combination of any other such configurations. In addition, the “memory” should be interpreted broadly to include any electronic component capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and the like. If a processor can read information from and/or write information to the memory, the memory is said to be in electronic communication with the processor. A memory integrated into the processor is in electronic communication with the processor.

In addition, terms such as first, second, A, B, (a), (b), etc. used in the following embodiments are only used to distinguish one component from another component, and the essence, order, or sequence of the corresponding component is not limited by the terms.

In addition, in the following embodiments, when a component is described as being “connected,” “coupled,” or “accessed” to another component, the component may be directly connected or accessed to the other component, but it should be understood that another component may be “connected,” “coupled,” or “accessed” between each component.

In addition, “comprises” and/or “comprising” used in the following embodiments does not exclude the presence or addition of one or more other components, steps, operations, and/or elements in the mentioned component, step, operation, and/or element.

In the present disclosure, “each of a plurality of A” may refer to each of all components included in the plurality of A, or may refer to each of some components included in the plurality of A.

Prior to describing various embodiments of the present disclosure, terms used will be described.

In the present disclosure, a “machine learning model” may include any model used to infer an answer to a given input. According to an embodiment, the machine learning model may include an artificial neural network model including an input layer, a plurality of hidden layers, and an output layer. Here, each layer may include a plurality of nodes. Also, in the present disclosure, the machine learning model may refer to an artificial neural network model, and the artificial neural network model may refer to a machine learning model.

In the present disclosure, a “descriptor” may include at least one instruction address for executing an artificial intelligence operation. Here, the instruction address may be an address of a storage area (e.g., a buffer) where an instruction is stored. Also, the descriptor may be associated with at least one job. For example, performing a single job may mean that at least one instruction associated with the descriptor is executed.

Hereinafter, various embodiments of the present disclosure will be described in detail according to the accompanying drawings.

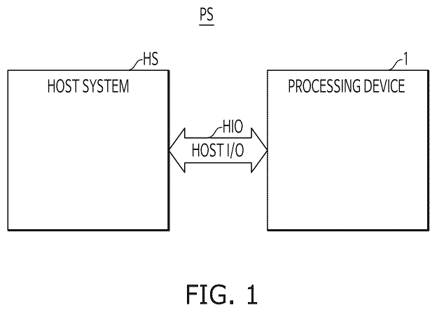

FIG. 1 is a block diagram illustrating a processing system PS according to some embodiments of the present disclosure. Referring to FIG. 1, the processing system PS according to some embodiments of the present disclosure may include a processing device 1, a host system HS, and a host interface HIO.

In an embodiment, the processing device 1 may be a device that performs an operation using an artificial neural network. The processing device 1 may be, for example, a device specialized in performing a deep learning operation job. However, the present embodiment is not limited thereto.

In an embodiment, the processing device 1 may include one or more accelerators such as a neural processing unit (NPU) specialized for a deep learning job, a graphics processing unit (GPU), or a central processing unit (CPU). However, the present disclosure is not limited thereto, and the processing device 1 may be other types of processing devices.

In an embodiment, the processing device 1 may include at least one processor. Also, the processing device 1 may include a memory that stores data processed by the processor. In an embodiment, a job pending queue for managing fully processed jobs is stored in the memory, and the processor may manage the job pending queue stored in the memory.

The host system HS may be a computing system that instructs an operation job to the processing device 1 and retrieves a result of the operation job. For example, the host system HS may transmit data associated with an artificial intelligence operation to the processing device 1, and receive an artificial intelligence operation result based on the transmitted data from the processing device 1. In an embodiment, the host system HS may be a computing system not specialized for the deep learning operation job compared to the processing device 1. However, the present embodiment is not limited thereto.

The host interface HIO may transmit data and/or a control signal between the processing device 1 and the host system HS. The host interface HIO may deliver, for example, a command and/or data of the host system HS to the processing device 1, and accordingly, the processing device 1 may perform the operation job. When the processing device 1 fully processes the operation job, a result thereof may be delivered to the host system HS through an interrupt request. The host interface HIO may be, for example, PCIe (PCI Express), but is not limited thereto.

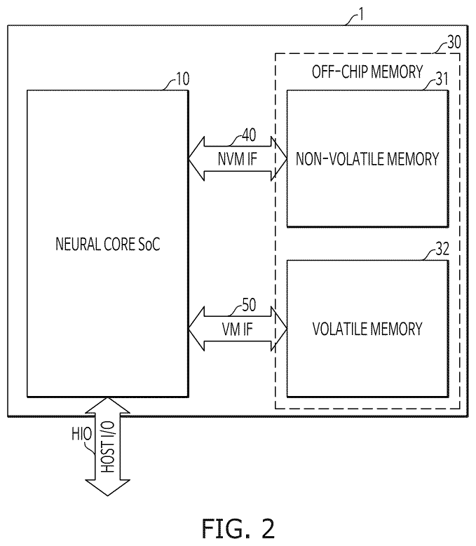

FIG. 2 is a block diagram illustrating the processing device 1 of FIG. 1 in detail. Referring to FIG. 2, the processing device 1 may include a neural core SoC 10, an off-chip memory 30, a non-volatile memory interface 40, and a volatile memory interface 50. In the description referring to FIG. 2, the processing device 1 is exemplarily described as being a neural network processing device.

The neural core SoC 10 may be a system on chip device. The neural core SoC 10 may include an accelerator serving as an artificial intelligence operation unit. The neural core SoC 10 may include, for example, at least one of a graphics processing unit (GPU), a field programmable gate array (FPGA), or an application-specific integrated circuit (ASIC). However, the present embodiment is not limited thereto.

The neural core SoC 10 may exchange data with other external operation units through a separate external interface. In addition, the neural core SoC 10 may be connected to a non-volatile memory 31 and a volatile memory 32 through the non-volatile memory interface 40 and the volatile memory interface 50, respectively.

The off-chip memory 30 may be a memory disposed outside a chip of the neural core SoC 10. The off-chip memory 30 may include the non-volatile memory 31 and the volatile memory 32.

The non-volatile memory 31 may be a memory that continuously maintains stored information even if power is not supplied. The non-volatile memory 31 may store one or more instructions for controlling an operation on the machine learning model described below. The non-volatile memory 31 may include, for example, at least one of Read-Only Memory (ROM), Programmable Read-Only Memory (PROM), Erasable Alterable ROM (EAROM), Erasable Programmable Read-Only Memory (EPROM), Electrically Erasable Programmable Read-Only Memory (EEPROM) (e.g., NAND Flash memory, NOR Flash memory), Ultra-Violet Erasable Programmable Read-Only Memory (UVEPROM), Ferroelectric Random Access Memory (FeRAM), Magnetoresistive Random Access Memory (MRAM), Phase-change Random Access Memory (PRAM), silicon-oxide-nitride-oxide-silicon (SONOS), Resistive Random Access Memory (RRAM), Nanotube Random Access Memory (NRAM), a magnetic computer storage device (e.g., a hard disk, a diskette drive, a magnetic tape), an optical disk drive, or a 3D XPoint memory. However, the present embodiment is not limited thereto.

Unlike the non-volatile memory 31, the volatile memory 32 may be a memory that continuously requires power to maintain stored information. The volatile memory 32 may include, for example, at least one of Dynamic Random Access Memory (DRAM), Static Random Access Memory (SRAM), Synchronous Dynamic Random Access Memory (SDRAM), or Double Data Rate SDRAM (DDR SDRAM). However, the present embodiment is not limited thereto.

The non-volatile memory interface 40 may include, for example, at least one of Parallel Advanced Technology Attachment (PATA), Small Computer System Interface (SCSI), Serial Attached SCSI (SAS), Serial Advanced Technology Attachment (SATA), or PCI Express (PCIe). However, the present embodiment is not limited thereto.

The volatile memory interface 50 may be, for example, at least one of Single Data Rate (SDR), Double Data Rate (DDR), Quad Data Rate (QDR), Octal Data Rate (ODR), or eXtreme Data Rate (XDR). However, the present embodiment is not limited thereto.

In an embodiment, the neural core SoC 10 may include at least one processor, and the processor included in the neural core SoC 10 may receive data and/or a command from the host system through the host interface HIO, and perform the artificial intelligence operation by applying the received data to the machine learning model. In an embodiment, the neural core SoC 10 may transmit result data for the artificial intelligence operation to the host system through the host interface HIO. For example, when completing an artificial intelligence operation associated with at least one job, the neural core SoC 10 may transmit a job completion report to the host system through the host interface HIO. In an embodiment, if an error occurs during performance of the artificial intelligence operation, the neural core SoC 10 may transmit a message associated with the error occurrence to the host system through the host interface HIO. In an embodiment, the neural core SoC 10 monitors a performance time of the artificial intelligence operation, and may transmit a timeout report to the host system through the host interface HIO when the performance time of the artificial intelligence operation exceeds a threshold time.

In an embodiment, a command queue storing a buffer descriptor may be stored in the off-chip memory 30. Additionally or alternatively, the command queue storing the buffer descriptor may be stored in at least one memory disposed inside the neural core SoC 10.

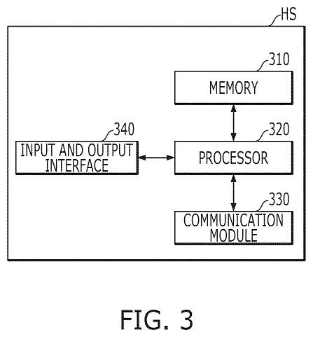

FIG. 3 is a block diagram illustrating the host system HS of FIG. 1 in detail. The host system HS may include a memory 310, a processor 320, a communication module 330, and an input/output interface 340. The host system HS may be configured to communicate information and/or data through a network using the communication module 330.

The memory 310 may include any non-transitory computer-readable recording medium. According to an embodiment, the memory 310 may include a permanent mass storage device such as a read only memory (ROM), a disk drive, a solid state drive (SSD), a flash memory, and the like. As another example, the permanent mass storage device such as the ROM, the SSD, the flash memory, the disk drive, and the like may be included in the host system HS as a separate permanent storage device distinct from the memory 310. In addition, an operating system and at least one program code (e.g., code for an artificial intelligence operation request, recovery target job determination, queue initialization or recovery, etc. installed and driven in the host system HS) may be stored in the memory 310. In FIG. 3, the memory 310 is illustrated as a single memory, but this is only for convenience of description, and the memory 310 may include a plurality of memories. In an embodiment, a job pending queue in which a fully processed job is stored may be included in at least one of the memory 310 or the permanent storage device.

Software components may be loaded from a computer-readable recording medium separate from the memory 310. This separate computer-readable recording medium may include a recording medium directly connectable to this host system HS, for example, a computer-readable recording medium such as a floppy drive, a disk, a tape, a DVD/CD-ROM drive, a memory card, and the like. As another example, the software components may be loaded into the memory 310 through the communication module 330 rather than the computer-readable recording medium. For example, at least one program may be loaded into the memory 310 based on a computer program (e.g., a program for an artificial intelligence operation request, recovery target job determination, queue initialization or recovery, etc.) installed by files that developers or a file distribution system distributing an installation file of an application provide through the communication module 330.

The processor 320 may be configured to process a command of the computer program by performing basic arithmetic, logic, and input/output operations. The command may be provided to a user terminal (not shown) or another external system by the memory 310 or the communication module 330. For example, the processor 320 may receive job data associated with at least one context from the user terminal or the other external system through the communication module 330.

The communication module 330 may provide a configuration or function for the user terminal (not shown) and the host system HS to communicate with each other through the network, and may provide a configuration or function for the host system HS to communicate with an external system (e.g., a separate cloud system, etc.). As an example, a control signal, a command, data, etc. provided under control of the processor 320 of the host system HS may be transmitted to the user terminal and/or the external system through the communication module 330 and a communication module of the user terminal and/or the external system via the network.

In addition, the input/output interface 340 of the host system HS may be a means for interfacing with a device (not shown) for input or output that may be connected to the host system HS or that the host system HS may include. For example, the input/output interface 340 may include at least one of a PCI express interface or an ethernet interface. In FIG. 3, the input/output interface 340 is illustrated as an element configured separately from the processor 320, but is not limited thereto, and the input/output interface 340 may be configured to be included in the processor 320. Additionally, the host system HS may include more components than the components of FIG. 3.

In an embodiment, the input/output interface 340 may include the host interface HIO formed between the host system HS and the processing device. Data, a command, a signal, a message, and the like may be transmitted and received through the host interface HIO.

The processor 320 of the host system HS may be configured to manage, process, and/or store information and/or data received from a plurality of user terminals and/or a plurality of external systems. In addition, the processor 320 may be configured to manage at least one queue/buffer. Also, the processor 320 may be further configured to manage the job pending queue described below.

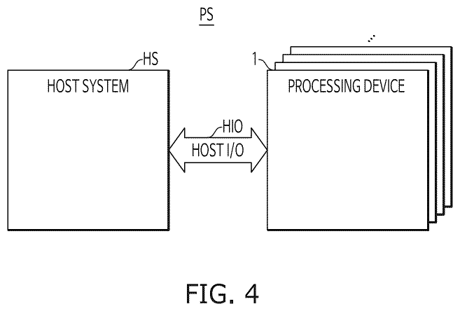

FIG. 4 is a block diagram illustrating a processing system PS according to some embodiments of the present disclosure.

Referring to FIG. 4, the processing device 1 may be plural. Each of the plurality of processing devices 1 may be connected to the host system HS through the host interface HIO. Although one host interface HIO is illustrated in FIG. 4, the host interface HIO may include a plurality of interfaces connecting each processing device 1 and the host system HS.

The plurality of processing devices 1 may exchange data and/or signals with each other. The plurality of processing devices 1 may transmit data and/or signals via a separate interface between each other without going through the host system HS. However, the present embodiment is not limited thereto.

In an embodiment, the plurality of processing devices may transmit and receive data including a job performance result to and from another processing device performing a job in a dependency relationship through the separate interface.

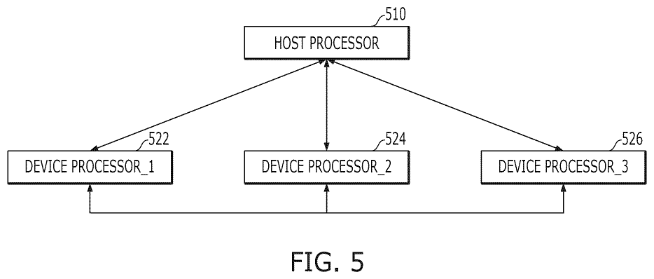

FIG. 5 is a diagram illustrating a relationship between a host processor 510 and device processors 522, 524, and 526 according to an embodiment of the present disclosure. Here, the host processor 510 corresponds to at least one processor (e.g., 320 of FIG. 3) included in the host system, and the device processors 522, 524, and 526 may correspond to at least one processor included in the processing device.

Referring to FIG. 5, the host processor 510 may transmit and receive data and/or a control signal to and from each of the device processors 522, 524, and 526. For example, the host processor 510 distributes a job associated with an artificial intelligence operation to each of the device processors 522, 524, and 526, and may receive a performance result for the distributed job from each of the device processors 522, 524, and 526. As another example, the host processor 510 may transmit an initialization command to each of the device processors 522, 524, and 526, and transmit data to each of the device processors 522, 524, and 526 so that at least one job stored in the job pending queue is recovered to the command queue.

Each of the device processors 522, 524, and 526 may transmit and receive data to and from each other. For example, in a process of performing a job associated with the artificial intelligence operation, each of the device processors 522, 524, and 526 may transmit and receive data including a job performance result to and from the other device processors 522, 524, and 526 performing jobs having a dependency relationship.

In an embodiment, a first job, a second job, and a third job associated with a first context may be transmitted to a first device processor 522, a second device processor 524, and a third device processor 526, respectively. Here, the first job may include a first command, a second command, and a third command, the second job may include a fourth command, a fifth command, and a sixth command, and the third job may include a seventh command, an eighth command, and a ninth command. In addition, each of the first job, the second job, and the third job associated with the first context may be in a dependency relationship with each other. For example, the fourth command, the fifth command, and the sixth command included in the second job may be performed only when the first command, the second command, and the third command included in the first job are all fully processed. As another example, the seventh command included in the third job may be performed only when the first command included in the first job is fully processed, and the fourth command included in the second job may be performed only when the seventh command is fully processed. An example of the dependency relationship between jobs may be applied in various ways, and the present disclosure is not limited to the above-described example.

According to various embodiments of the present disclosure, the host processor does not adopt a scheme of distributing jobs by considering all dependency relationships by configuring a separate queue before distributing the jobs, but after distributing a plurality of jobs in the dependency relationship to the plurality of processing devices, each device processor in the dependency relationship with each other may transmit and receive data to and from each other and execute a command. Through such a configuration, overhead of a host may be effectively reduced. In addition, through such a configuration, a dependency problem is processed in real time through dynamic interaction between devices, and a bottleneck phenomenon that may occur in a job distribution process is prevented and a processing speed of the system may be improved.

According to various embodiments of the present disclosure, the host system configures the job pending queue storing the fully processed job, so that a job in a dependency relationship that is already fully processed may be normally recovered even in a queue initialization and recovery process. Through this, upon reset, although the dependency relationship is not resolved, deletion of the already fully processed job is prevented, and stability of the system and continuity of a job flow may be guaranteed.

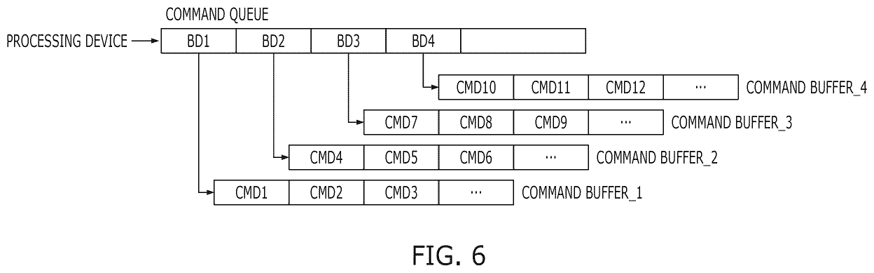

Hereinafter, a method in which the host processor 510 and the device processors 522, 524, and 526 manage jobs will be described with reference to FIGS. 6 to 14. Management of jobs illustrated in FIGS. 6 to 14 described below may be performed by the host processor 510 and/or the device processors 522, 524, and 526. For instance, the management of jobs illustrated in FIGS. 6 to 14 may be associated with an operation of a driver supported by the host processor 510, or may be associated with an operation of a driver supported by each of the device processors 522, 524, and 526.

FIG. 6 is a diagram illustrating an example of a command queue and a command buffer included in a processing device (e.g., 1 of FIG. 1) according to an embodiment of the present disclosure. Referring to FIG. 6, the processing device may include a command queue (COMMAND QUEUE) and a plurality of command buffers (COMMAND BUFFER_1, COMMAND BUFFER_2, COMMAND BUFFER_3, COMMAND BUFFER_4). The command queue and each of the plurality of command buffers may be managed by at least one device processor (e.g., 522, 524, 526 of FIG. 5) included in the processing device. Hereinafter, an operation of the processing device may be understood as an operation of the device processor, and vice versa. Each of the plurality of command buffers in the present embodiment may be logically separated or physically separated in a storage area.

The processing device may receive job data from the host system. Here, the job data is data associated with the artificial intelligence operation, and may be generated based on data and/or a command received from the user terminal. Also, the job data may include at least one command. For instance, the host system may receive an artificial intelligence operation request from the user terminal, generate the job data based on the data and/or the command included in the artificial intelligence operation request, and then transmit the job data to the processing device.

In response to receiving the job data from the host system, the processing device may store at least one command included in the job data in at least one command buffer.

When at least one command is stored in the command buffer, a buffer descriptor may be generated and stored in the command queue. The device processor may generate the buffer descriptor, and store the generated buffer descriptor in the command queue. In an embodiment, the buffer descriptor may include an address and size of at least one command stored in the command buffer. In the present embodiment, it is illustrated that the buffer descriptor including the address of the command buffer is stored in the command queue, but the present disclosure is not limited thereto, and a descriptor including an address of a storage area other than the command buffer may be stored in the command buffer. However, for convenience of description, hereinafter, it will be described that the buffer descriptor is stored in the command queue.

Referring to FIG. 6, a plurality of commands CMD1, CMD2, and CMD3 included in first job data may be stored in a first command buffer COMMAND BUFFER_1, and a first buffer descriptor BD1 associated with the plurality of commands CMD1, CMD2, and CMD3 may be stored in the command queue. In addition, a plurality of commands CMD4, CMD5, and CMD6 included in second job data may be stored in a second command buffer COMMAND BUFFER_2, and a second buffer descriptor BD2 associated with the plurality of commands CMD4, CMD5, and CMD6 may be stored in the command queue. In addition, a plurality of commands CMD7, CMD8, and CMD9 included in third job data may be stored in a third command buffer COMMAND BUFFER_3, and a third buffer descriptor BD3 associated with the plurality of commands CMD7, CMD8, and CMD9 may be stored in the command queue. In addition, a plurality of commands CMD10, CMD11, and CMD12 included in fourth job data may be stored in a fourth command buffer COMMAND BUFFER_4, and a fourth buffer descriptor BD4 associated with the plurality of commands CMD10, CMD11, and CMD12 may be stored in the command queue. Here, the first job data to the fourth job data may be associated with contexts different from each other, but are not limited thereto. At least two of the first job data to the fourth job data may be associated with the same context. As illustrated in the example of FIG. 6, the buffer descriptor may be stored in the command queue, and an actual command may be stored in the command buffer.

In such a system environment, when a command execution period arrives, the device processor may obtain a buffer descriptor having a highest priority stored in the command queue, and execute at least one command associated with the obtained buffer descriptor. In this case, for example, the device processor may perform the artificial intelligence operation by applying data included in at least one command to the machine learning model, and transmit an operation result to the host system.

According to an embodiment, the device processor may manage tracking data associated with the artificial intelligence operation job. At least one buffer descriptor associated with a command not yet executed and an order of the buffer descriptor may be stored in the tracking data. Additionally or alternatively, an address of at least one command buffer associated with the buffer descriptor may be stored in the tracking data. Command queue initialization and recovery described below may be performed based on the tracking data.

According to an embodiment, when the buffer descriptor is stored in the command queue, the buffer descriptor stored in the command queue may also be stored in the tracking data. According to some embodiments, when the buffer descriptor is stored in the command queue, at least one command buffer address associated with the buffer descriptor may be stored in the tracking data. The buffer descriptor and/or the address of the command buffer stored in the tracking data may be stored in a First-In-First-Out (FIFO) structure. That is, the buffer descriptor and/or the address of the command buffer stored in the tracking data may have an order. According to an embodiment, when the device processor fully processes the artificial intelligence operation associated with at least one job data, the buffer descriptor and/or the address of the command buffer associated with this operation result may be deleted from the tracking data. Additionally or alternatively, in response to receiving a tracking data deletion command from the host system, the device processor may delete the buffer descriptor and/or the address of the command buffer included in the tracking data deletion command from the tracking data. When deleting a specific context and/or a specific job from the job pending queue, the host system may transmit the tracking data deletion command to the processing device so that the buffer descriptor and/or the address of the command buffer associated with the specific context and/or the specific job are deleted from the tracking data.

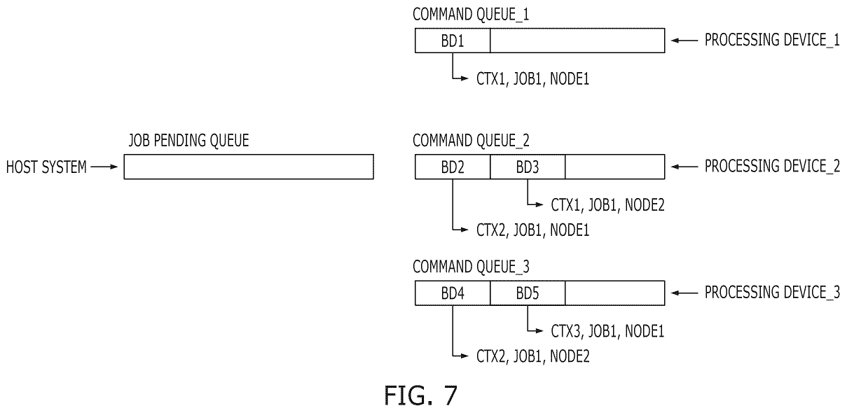

FIG. 7 is a diagram illustrating an example of a job pending queue included in a host system (e.g., HS of FIG. 1) and a command queue included in each processing device (e.g., 1 of FIG. 1) according to an embodiment of the present disclosure. Referring to FIG. 7, the host system HOST SYSTEM may include a job pending queue JOB PENDING QUEUE. In addition, a first processing device PROCESSING DEVICE_1 may include a first command queue COMMAND QUEUE_1, a second processing device PROCESSING DEVICE_2 may include a second command queue COMMAND QUEUE_2, and a third processing device PROCESSING DEVICE_3 may include a third command queue COMMAND QUEUE_3. The job pending queue may be managed by at least one host processor (e.g., 510 of FIG. 5) included in the host system. Hereinafter, an operation of the host system may be understood as an operation of the host processor, and vice versa. In addition, each of the command queues may be managed by at least one device processor (e.g., 522, 524, 526 of FIG. 5) included in each of the processing devices. Hereinafter, an operation of the processing device may be understood as an operation of the device processor, and vice versa.

The host system may distribute a plurality of job data associated with at least one context to the plurality of processing devices. For example, the host system may receive an artificial intelligence operation request from the user terminal, generate the job data based on data and/or a command included in the artificial intelligence operation request, and then distribute the job data to each of the processing devices. Each of the processing devices may generate a buffer descriptor based on the received job data, and store the generated buffer descriptor in the command queue. Also, the host system may store a buffer descriptor associated with a fully processed job in the job pending queue.

In an embodiment, the buffer descriptor may further include context data, job dependency data, and node data. The context data may include information on a context associated with the buffer descriptor. The job dependency data may include information for indicating jobs in a dependency relationship with each other. For example, there may be a dependency relationship between buffer descriptors having identical context data and job dependency data. In the example of FIG. 7, the first buffer descriptor BD1 and the third buffer descriptor BD3 may be in a dependency relationship with each other. In addition, the second buffer descriptor BD2 and the fourth buffer descriptor BD4 may be in a dependency relationship with each other. The node data may include information for identifying to which processing device the job data has been distributed. However, this is only an example, and additional information may be further stored in the buffer descriptor, or the above-described information may be stored as another type of data, or information of at least one of the context data, the job dependency data, or the node data may not be stored.

Referring to the example of FIG. 7, the host system may distribute job data associated with a first context CTX1 to the first processing device and the second processing device. In an embodiment, at least some of commands included in the job data distributed to each of the first processing device and the second processing device may be different. In an embodiment, at least some of commands included in the job data distributed to each of the first processing device and the second processing device may overlap each other. Also, the host system may distribute job data associated with a second context CTX2 to the second processing device and the third processing device. Also, the host system may transmit job data associated with a third context CTX3 to the third processing device. Each of the first processing device to the third processing device may generate a buffer descriptor based on the received data, and store the generated buffer descriptor in each of the first command queue to the third command queue. Each of the first processing device to the third processing device may perform a job (e.g., an artificial intelligence operation) by executing a command associated with the buffer descriptor in an order stored in the command queue. For example, the second processing device may execute a command associated with the second buffer descriptor BD2, and when the execution is fully processed, execute a command associated with the third buffer descriptor BD3. In addition, the third processing device may execute a command associated with the fourth buffer descriptor BD4, and when the execution is fully processed, execute a command associated with the fifth buffer descriptor BD5.

Meanwhile, the processing device may fail in the artificial intelligence operation based on the data received from the host system, or detect an error related to the artificial intelligence operation. In this case, the processing device may transmit an error message to the host system.

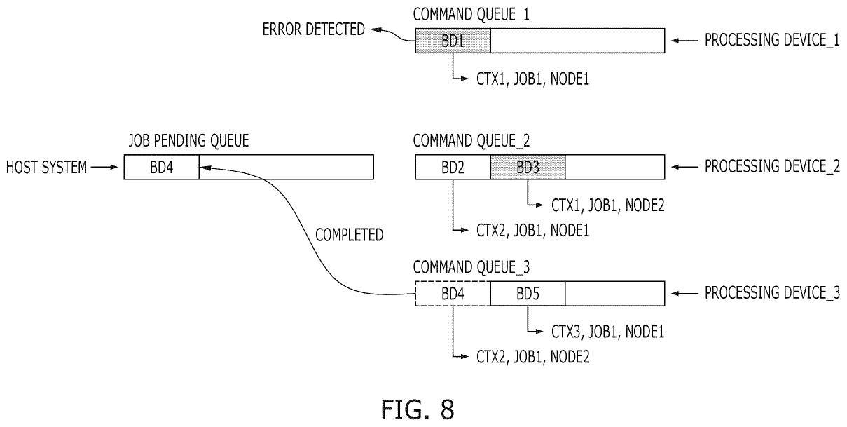

FIG. 8 is a diagram illustrating an example in which an error exists in an artificial intelligence operation associated with a first context according to an embodiment of the present disclosure.

Referring to FIG. 8, the third processing device is illustrated as having fully processed performing an artificial intelligence operation associated with the fourth buffer descriptor BD4. In this case, the third processing device may transmit a job performance result including a job completion report to the host system. In response to receiving the job completion report, the host system may identify a job associated with the received job completion report, and process the identified job as fully processed. In an embodiment, the third processing device may transmit the fourth buffer descriptor BD4 to the host system together with the job completion report. Also, the host system may store the fully processed job in the job pending queue. Similarly, the host system may store the fully processed job in the job pending queue in a form of the buffer descriptor, but is not limited thereto.

Meanwhile, the processing device may execute the artificial intelligence operation based on the data and/or the command received from the host system, and an error may occur while the artificial intelligence operation is being executed. Here, the artificial intelligence operation may be an operation associated with graphics. For instance, the artificial intelligence operation may be a rendering operation. Also, the rendering may be a result mainly of a pixel operation. For example, rendering in the machine learning model (i.e., the artificial intelligence operation associated with rendering) may be an operation result associated with at least one of weight data or a multi-layer perceptron. When a job associated with graphics (graphics job) is performed, overhead may not significantly occur even if a program, constant data, input data, and the like are included in one command buffer.

Referring to the example of FIG. 8, an error may exist in the artificial intelligence operation associated with the first context CTX1. The first processing device may detect the error while performing an artificial intelligence operation associated with the first buffer descriptor BD1. When detecting that the error has occurred in the artificial intelligence operation, the first processing device may transmit an error message to the host system. Meanwhile, although an error may exist also in the third buffer descriptor BD3 associated with the first context CTX1, since the second processing device is normally executing the command associated with the second buffer descriptor BD2, there is a possibility that the error associated with the third buffer descriptor BD3 is not detected.

In response to receiving the error message from the first processing device, the host system may determine that an error associated with at least one context has occurred. In this case, the host system may initialize (reset) the job pending queue and the command queue. Here, initializing the job pending queue and the command queue may mean deleting data stored in the job pending queue and the command queue. In an embodiment, the host system may initialize the command queue included in each of the processing devices by transmitting an initialization command to each of the processing devices. As another example, the host system may initialize the command queue in a manner of directly accessing a memory shared with the processing device and deleting data stored in the command queue.

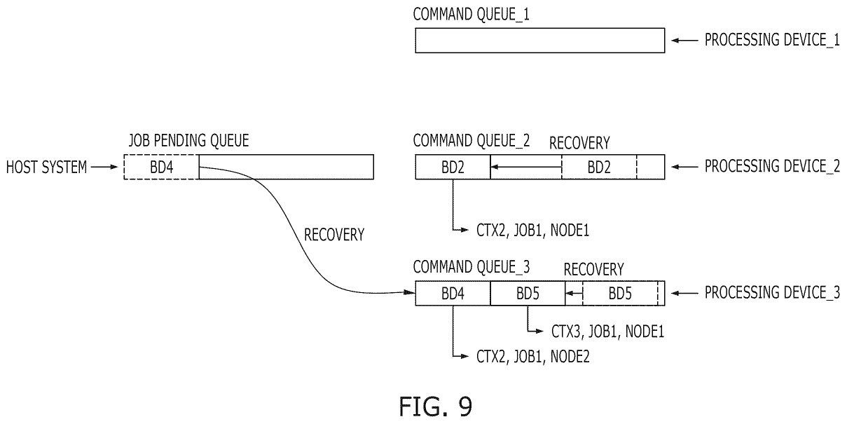

FIG. 9 is a diagram illustrating a process in which a command queue is recovered after being initialized according to an embodiment of the present disclosure. Referring to FIG. 9, the first buffer descriptor BD1 and the third buffer descriptor BD3 associated with the context in which the error occurred may not be recovered, and the second buffer descriptor BD2, the fourth buffer descriptor BD4, and the fifth buffer descriptor BD5 not associated with the context in which the error occurred may be recovered.

In an embodiment, when determining that the error associated with at least one context has occurred, the host system identifies the context associated with the error, and may determine a recovery target job based on the identified context. Referring to FIGS. 8 and 9, the host system may receive an error message from the first processing device. Based on the error message, the host system may determine that the error associated with the first context CTX1 has occurred. The host system may determine a job not associated with the first context CTX1 as the recovery target job. Specifically, the host system may identify, as a first recovery target job, a job other than the first context CTX1 among jobs stored in the job pending queue, and identify, as a second recovery target job, a job other than the first context among jobs stored in the command queue. Here, the first recovery target job may mean a prior recovery target job, and the second recovery target job may mean a subsequent recovery target job. That is, the host system may preferentially recover the job stored in the job pending queue, and recover the job stored in the command queue subsequently.

In the example illustrated in FIG. 9, the host system may preferentially recover the fourth buffer descriptor BD4. Based on node data included in the fourth buffer descriptor BD4, the host system may transmit the fourth buffer descriptor BD4 to the third processing device. Additionally or alternatively, the host system may transmit job data extracted based on the fourth buffer descriptor BD4 to the third processing device. In response to receiving the fourth buffer descriptor BD4 from the host system, the third processing device may preferentially recover the fourth buffer descriptor BD4 to the third command queue. Thereafter, the third processing device may recover the fifth buffer descriptor BD5, which was stored in the third command queue, subsequently.

Since the second processing device does not receive the prior recovery target job from the host system, it may recover the second buffer descriptor BD2 which was stored in the second command queue.

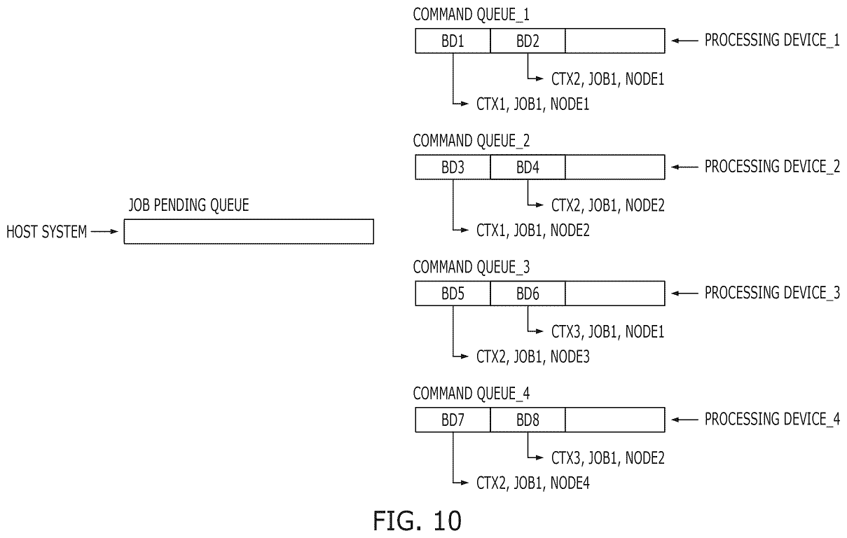

FIG. 10 is a diagram illustrating an example of a job pending queue included in a host system (e.g., HS of FIG. 1) and a command buffer included in each processing device (e.g., 1 of FIG. 1) according to an embodiment of the present disclosure. Hereinafter, descriptions overlapping with the description described above with reference to FIG. 7 will be omitted.

The host system may distribute a plurality of job data associated with at least one context to the plurality of processing devices. Each of the processing devices may generate a buffer descriptor based on the received job data, and store the generated buffer descriptor in the command queue. In the example of FIG. 10, the first processing device may generate a first buffer descriptor BD1 and a second buffer descriptor BD2 and store them in the first command queue, and the second processing device may generate a third buffer descriptor BD3 and a fourth buffer descriptor BD4 and store them in the second command queue. In addition, the third processing device may generate a fifth buffer descriptor BD5 and a sixth buffer descriptor BD6 and store them in the third command queue, and the fourth processing device may generate a seventh buffer descriptor BD7 and an eighth buffer descriptor BD8 and store them in the fourth command queue.

In addition, there may be a dependency relationship between buffer descriptors having identical context data and job dependency data. In the example of FIG. 10, the first buffer descriptor BD1 and the third buffer descriptor BD3 may be in a dependency relationship with each other. In addition, the second buffer descriptor BD2, the fourth buffer descriptor BD4, the fifth buffer descriptor BD5, and the seventh buffer descriptor BD7 may be in a dependency relationship with each other. In addition, the sixth buffer descriptor BD6 and the eighth buffer descriptor BD8 may be in a dependency relationship with each other.

Meanwhile, the processing device may detect a timeout while performing the artificial intelligence operation. Here, the timeout may be detected when an execution time of a command associated with the artificial intelligence operation exceeds a predetermined threshold time. When detecting the timeout, the processing device may transmit a timeout report to the host system. When receiving the timeout report from the processing device, the host system may provide a response to a user terminal associated with the received timeout report. The host system may provide a quick response to timeout detection to the user terminal before identifying whether the error occurs. Through such a configuration, a user may quickly recognize a situation and perform a necessary countermeasure, and stability of the entire system is improved and user experience may be improved.

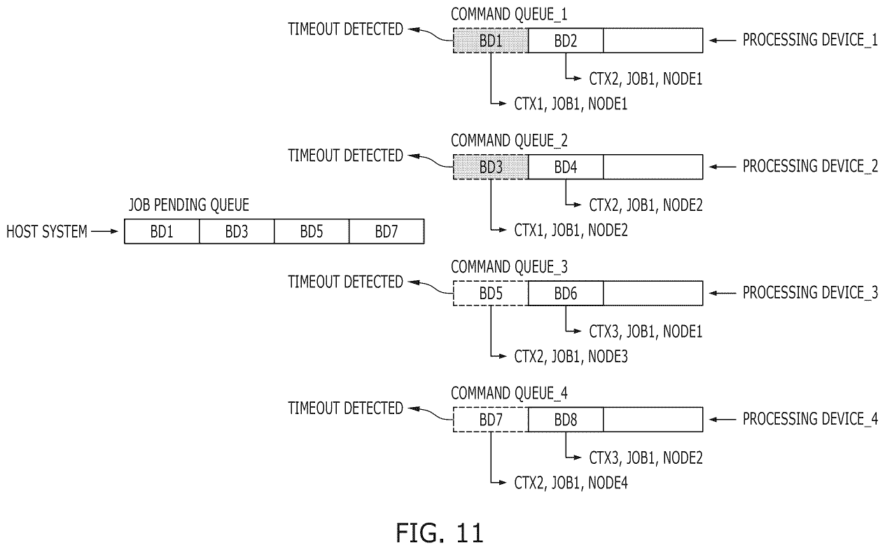

FIG. 11 is a diagram illustrating an example in which a timeout is detected according to an embodiment of the present disclosure. Hereinafter, descriptions overlapping with the description described above with reference to FIG. 8 will be omitted.

Referring to FIG. 11, it is illustrated that a timeout is detected in the first processing device to the fourth processing device. Causes for which the timeout is detected may be various. As an example, the timeout may occur when data synchronization is delayed due to a dependency between jobs. For example, if there is no response while another device waits for a job because a specific job is not fully processed in a multi-device environment, the timeout may be detected. As another example, the timeout may occur even when a dependency relationship not intended by the user is set. For example, if a result for a specific job is transmitted to a device not intended by the user in the multi-device environment, a hang of waiting indefinitely for a response may occur in the originally intended device.

Information that a timeout has been detected in the processing device does not necessarily mean that there is a problem in a context associated with the job in which the timeout is detected. Therefore, even if the timeout is detected, a process of determining whether there is a problem in the corresponding context may be necessary.

For example, in the example of FIG. 11, a dependency relationship between the first buffer descriptor BD1 and the third buffer descriptor BD3 associated with the first context CTX1 may be set in a direction not intended by the user. The first processing device and the second processing device may determine that the job associated with the first buffer descriptor BD1 and the job associated with the third buffer descriptor BD3 are not executed within a predetermined threshold time, and detect the timeout.

Meanwhile, the fifth buffer descriptor BD5 and the seventh buffer descriptor BD7 associated with the second context CTX2 may be in a dependency relationship with at least one of the second buffer descriptor BD2 or the fourth buffer descriptor BD4 associated with the second context CTX2. Therefore, the third processing device and the fourth processing device may wait for a response from at least one of the first processing device or the second processing device in a process of executing commands included in the fifth buffer descriptor BD5 and the seventh buffer descriptor BD7. As described above, even when there is no problem in the second context, a timeout may be detected while executing a command associated with the second context.

In an embodiment, the host system may receive a timeout report from at least one of the plurality of processing devices. In an embodiment, the host system may receive a buffer descriptor associated with the timeout report. In response to receiving the timeout report, the host system may identify a job associated with the received timeout report, and process the identified job as fully processed. Also, the host system may store a buffer descriptor associated with the fully processed job in the job pending queue. Here, the timeout report may include information that a timeout has been monitored for a job assigned to the processing device, but is not limited thereto. In an embodiment, in response to receiving the timeout report, the host system may identify a context associated with the timeout report, and transmit the timeout report to a subject that transmitted the identified context to the host system. For example, the host processor may transmit the timeout report to the user terminal or the external system associated with the identified context, but is not limited thereto.

In the example of FIG. 11, the host system may receive a timeout report from the first processing device to the fourth processing device. Additionally, the host system may receive the first buffer descriptor BD1, the third buffer descriptor BD3, the fifth buffer descriptor BD5, and the seventh buffer descriptor BD7 from the first processing device to the fourth processing device. Also, based on the received timeout report, the host system may store the first buffer descriptor BD1, the third buffer descriptor BD3, the fifth buffer descriptor BD5, and the seventh buffer descriptor BD7 in the job pending queue. Also, in response to receiving the timeout report, the host system may transmit the timeout report to a user terminal associated with the first context CTX1 and a user terminal associated with the second context CTX2.

In an embodiment, the host processor may determine that an error associated with at least one context has occurred based on the timeout report received from the at least one processing device. For example, the host processor counts a number of received timeout reports, and when determining that timeout reports have been received for all jobs included in a specific context, may determine that an error associated with the specific context has occurred.

In the example of FIG. 11, based on the received timeout reports, the host system may determine that a reception count of the timeout report associated with the first context CTX1 is 2 times, and a reception count of the timeout report associated with the second context CTX2 is 2 times. Here, the host system may determine that a timeout report has not been received for at least one job included in the second context CTX2, and determine that an error associated with the second context CTX2 has not occurred. On the other hand, the host system may determine that timeout reports have been received for all jobs included in the first context CTX1, and determine that an error associated with the first context CTX1 has occurred. In this case, the host system may initialize the job pending queue and the command queue.

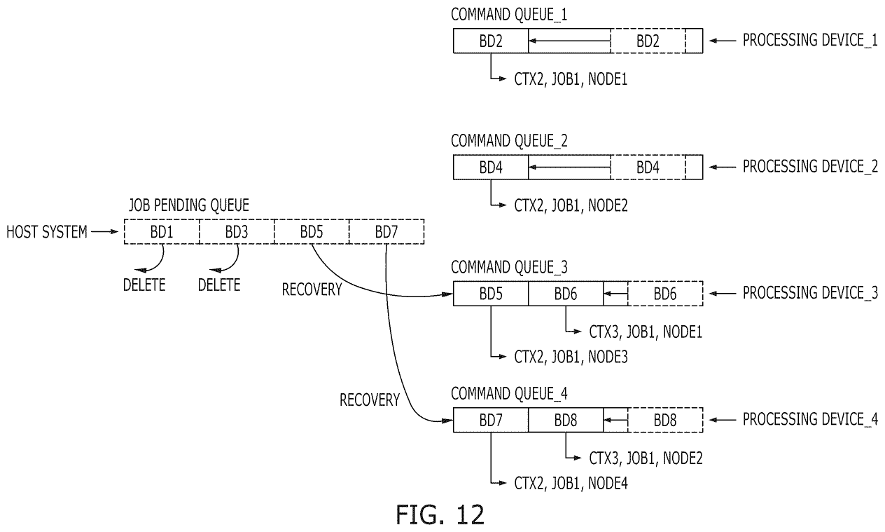

FIG. 12 is a diagram illustrating a process in which a command queue is recoverd after being initialized according to an embodiment of the present disclosure. Hereinafter, descriptions overlapping with the description described above with reference to FIG. 9 will be omitted. Referring to FIG. 12, the first buffer descriptor BD1 and the third buffer descriptor BD3 associated with the context in which the error occurred may not be recovered, and the second buffer descriptor BD2 and the fourth buffer descriptor BD4 to the eighth buffer descriptor BD8 not associated with the context in which the error occurred may be recovered.

In an embodiment, the host system may determine a job not associated with the context in which the error occurred as a recovery target job. In the example of FIG. 12, the host system may not determine the first buffer descriptor BD1 and the third buffer descriptor BD3 associated with the first context CTX1 as the recovery target job. Also, the host system may determine the second buffer descriptor BD2 and the fourth buffer descriptor BD4 to the eighth buffer descriptor BD8 associated with the second context CTX2 or the third context CTX3 as the recovery target job.

In an embodiment, the host system may identify, as a first recovery target job, a job stored in the job pending queue among the recovery target jobs, and determine, as a second recovery target job, a job stored in the command queue among the recovery target jobs. In the example of FIG. 12, the host system may determine the fifth buffer descriptor BD5 and the seventh buffer descriptor BD7 as the first recovery target job, and determine the second buffer descriptor BD2, the fourth buffer descriptor BD4, the sixth buffer descriptor BD6, and the eighth buffer descriptor BD8 as the second recovery target job.

In an embodiment, the host system may recover the first recovery target job, which is a prior recovery target job, prior to recovering the second recovery target job, and sequentially recover the second recovery target job, which is a subsequent recovery target job, to have an order subsequent to the first recovery target job. In the example of FIG. 12, based on node data included in the fifth buffer descriptor BD5 and the seventh buffer descriptor BD7, the host system may transmit the fifth buffer descriptor BD5 and the seventh buffer descriptor BD7 to the third processing device and the fourth processing device. Additionally or alternatively, the host system may transmit job data extracted based on the fifth buffer descriptor BD5 and the seventh buffer descriptor BD7 to the third processing device and the fourth processing device. In response to receiving the fifth buffer descriptor BD5 and the seventh buffer descriptor BD7 from the host system, the third processing device and the fourth processing device may preferentially recover the fifth buffer descriptor BD5 and the seventh buffer descriptor BD7 to the third command queue and the fourth command queue, respectively. Thereafter, the third processing device and the fourth processing device may recover the sixth buffer descriptor BD6 and the eighth buffer descriptor BD8, which were stored in the third command queue and the fourth command queue, subsequently.

Since the first processing device and the second processing device do not receive the prior recovery target job from the host system, they may recover the second buffer descriptor BD2 and the fourth buffer descriptor BD4 which were stored in the first command queue and the second command queue.

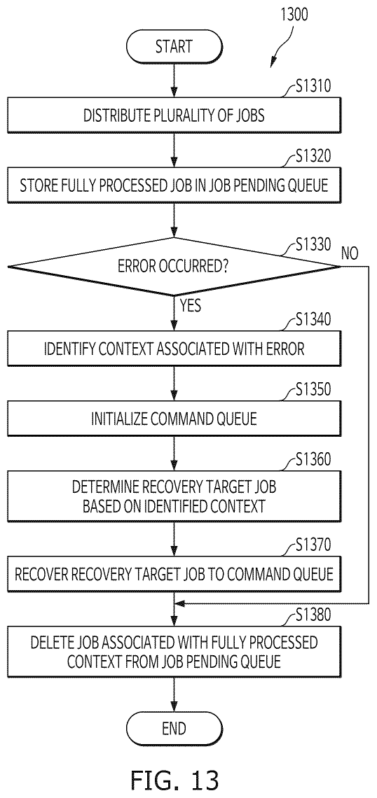

FIG. 13 is a flowchart illustrating a job management method 1300 according to an embodiment of the present disclosure. The method 1300 illustrated in FIG. 13 may be performed by at least one host processor (e.g., 510 of FIG. 5) included in the host system. For convenience of description, it will be described that each step illustrated in FIG. 13 is performed by the host processor illustrated in FIG. 5. The method 1300 according to FIG. 13 may be initiated when the host processor receives at least one context including a plurality of jobs.

The processor may distribute a plurality of jobs extracted from at least one context to a plurality of processing devices (S1310). Here, the context refers to a unit of operation/command that the user terminal or another external system requests from the host system, and one context may include at least one job. Also, the job refers to a unit of operation/command assigned to be performed by each processing device, and one job may include at least one command. However, the present disclosure is not limited thereto, and a unit of operation/command assigned to the host system and/or the processing device may be defined differently.

The processor may store a fully processed job in a job pending queue included in the host system (S1320). In an embodiment, the processor may receive a job completion report from at least one of the plurality of processing devices. In response to receiving the job completion report, the processor may identify a job associated with the received job completion report, and process the identified job as fully processed. Here, the job completion report may include information that the job assigned to the processing device has been normally fully processed, but is not limited thereto. In an embodiment, the processor may receive a timeout report from at least one of the plurality of processing devices. In response to receiving the timeout report, the processor may identify a job associated with the received timeout report, and process the identified job as fully processed. Here, the timeout report may include information that a timeout has been monitored for a job assigned to the processing device, but is not limited thereto. In an embodiment, in response to receiving the timeout report, the processor may identify a context associated with the timeout report, and transmit the timeout report to a subject that transmitted the identified context to the host system. For example, the processor may transmit the timeout report to a user terminal or an external system associated with the identified context, but is not limited thereto.

The processor may determine whether an error associated with at least one context has occurred (S1330). In an embodiment, the processor may receive an error message from at least one of the plurality of processing devices. In response to receiving the error message, the processor may determine that an error associated with at least one context has occurred. In an embodiment, the processor may determine that an error associated with at least one context has occurred based on a timeout report received from at least one processing device. For example, the processor counts a number of received timeout reports, and when determining that timeout reports have been received for all jobs included in a specific context, may determine that an error associated with the specific context has occurred.

When determining that the error has not occurred, the processor may not perform steps S1340 to S1370 related to command queue initialization and recovery.

When determining that the error has occurred, the processor may identify a context associated with the error (S1340). In an embodiment, the processor may identify a job in which the error occurred based on the received error message, and determine a context associated with the identified job as the context associated with the error. In an embodiment, the processor may count a number of received timeout reports, and determine a context in which timeout reports have been received for all jobs as the context associated with the error. For convenience, the context associated with the error will be referred to as a first context.

The processor may initialize each of a plurality of command queues included in the plurality of processing devices S1350. For example, the processor may initialize each of the plurality of command queues included in the plurality of processing devices by transmitting an initialization command to each processing device. As another example, the processor may initialize the command queue in a manner of directly accessing a memory shared with the processing device and deleting data stored in the command queue. In addition to this, the processor may generate an interrupt signal to cause the processing device to perform an initialization job of the command queue by itself. In the present disclosure, a scheme in which the processor initializes the command queue is not limited thereto, and the initialization job may be performed in various ways according to an interface and/or communication protocol between the host system and the processing device. Additionally, the processor may initialize the job pending queue together while initializing the command queue.

The processor may determine a recovery target job based on the identified first context S1360. In an embodiment, the processor may identify, as a first recovery target job, a job other than the first context among jobs stored in the job pending queue. Also, the processor may identify, as a second recovery target job, a job other than the first context among jobs stored in a command queue included in each processing device. Here, the first recovery target job may refer to a prior recovery target job, and the second recovery target job may refer to a subsequent recovery target job.

The processor may recover the recovery target job to the command queue S1370. In an embodiment, the first recovery target job, which is a prior recovery target job, may be preferentially recovered, and the second recovery target job, which is a subsequent recovery target job, may be sequentially recovered to have an order subsequent to the first recovery target job. In an embodiment, the processor may preferentially recover the recovery target job stored in the job pending queue, and recover the recovery target job stored in each command queue subsequently. In an embodiment, each job includes node data, and the node data may be associated with at least one processing device. Based on node data included in each first recovery target job, the processor may transmit each first recovery target job to a processing device associated with each first recovery target job. Additionally or alternatively, the processor may transmit a buffer descriptor associated with the first recovery target job to the processing device associated with each first recovery target job.

The processor may delete a job associated with a fully processed context from the job pending queue S1380. In an embodiment, when determining that all jobs included in the context are fully processed, the processor may determine that the context is fully processed. For example, a second context may include a first job and a second job. At this time, the processor may determine whether the first job is fully processed and determine whether the second job is fully processed. In response to determining that the first job and the second job are fully processed, the processor may determine that the second context is fully processed. In an embodiment, the processor may count a completion count of a job associated with the second context, and determine that the second context is fully processed in response to determining that the counted completion count is equal to a number of jobs included in the second context. In an embodiment, when deleting a specific context and/or a specific job from the job pending queue, the processor may transmit a tracking data deletion command to the processing device so that a buffer descriptor and/or an address of a command buffer associated with the specific context and/or the specific job are deleted from tracking data.

The flowchart and description described above using FIG. 13 are only an example, and may be implemented differently in some embodiments. For example, in some embodiments, an order of each step may be changed, some steps may be repeatedly performed, some steps may be omitted, or some steps may be added.

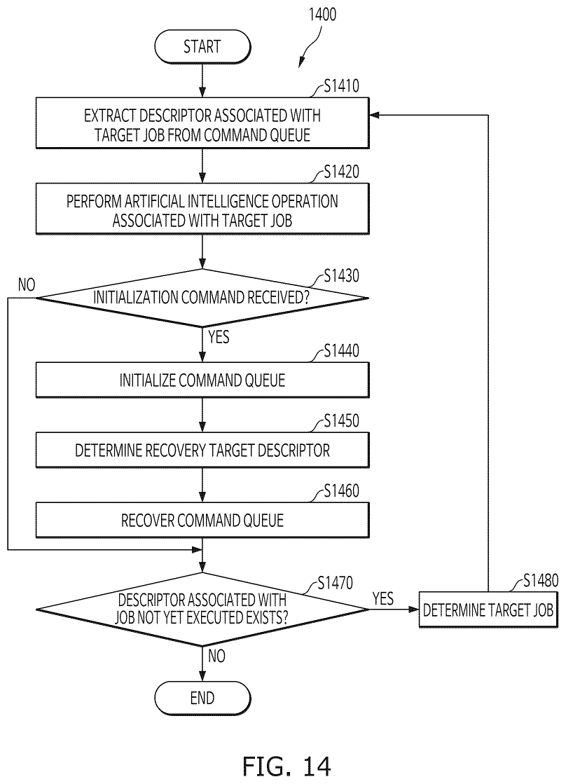

FIG. 14 is a flowchart illustrating a job recovery method 1400 according to an embodiment of the present disclosure. The method 1400 illustrated in FIG. 14 may be performed by at least one device processor (e.g., at least one of 522, 524, 526 of FIG. 5) included in the processing device. For convenience of description, it will be described that each step illustrated in FIG. 14 is performed by the device processor illustrated in FIG. 5. The method 1400 according to FIG. 14 may be initiated when the processor stores a descriptor in the command queue. In an embodiment, the descriptor may include a buffer descriptor.

The processor may extract a descriptor associated with a target job that is an execution target among a plurality of jobs from the command queue S1410. Here, the target job is a job executed in a current cycle, and the descriptor associated with this job may be stored in advance in the command queue.

Thereafter, the processor may perform an artificial intelligence operation associated with the target job by executing at least one command associated with the extracted descriptor S1420. According to an embodiment, the executed at least one command may be associated with inference performed in the processing device.

In an embodiment, the processor may determine whether an error occurs while performing the artificial intelligence operation. When determining that the error has occurred, the processor may transmit an error message to the host system.

In an embodiment, the processor may detect a timeout while performing the artificial intelligence operation. Here, the timeout may be detected when an execution time of a command associated with the artificial intelligence operation exceeds a predetermined threshold time. When detecting the timeout, the processor may transmit a timeout report to the host system.

Subsequently, the processor may determine whether an initialization command has been received while performing the artificial intelligence operation S1430. When determining that the initialization command has not been received, the processor may perform step S1470.

When determining that the initialization command has been received, the processor may initialize the command queue S1440. Here, initializing the command queue may mean deleting data stored in the command queue.

According to an embodiment, the processor may identify a context associated with a job in which the error occurred based on the initialization command, and control the command queue so that an additional descriptor associated with the identified context is not stored in the command queue. Also, based on the initialization command, the processor identifies the context associated with the job in which the error occurred, and when determining that an additional job not associated with the identified context has occurred, may store a descriptor associated with the additional job in the command queue before initializing the command queue. Here, the context may be associated with at least one of a specific user or a specific port.

Subsequently, the processor may determine a recovery target descriptor S1450. In an embodiment, the processor may receive a first recovery target job associated with the recovery target descriptor from the host system. Additionally or alternatively, the processor may receive a descriptor associated with the first recovery target job from the host system. Here, the first recovery target job may mean a job that needs to be preferentially recovered. In an embodiment, the processor may receive a second recovery target job associated with the recovery target descriptor from the host system. Here, the second recovery target job may mean a job to be recovered subsequently. Additionally or alternatively, the processor may identify a descriptor associated with the job in which the error occurred based on the initialization command, and determine a descriptor excluding the identified descriptor among descriptors stored in the command queue as the second recovery target job. In an embodiment, the processor may determine descriptors associated with the first recovery target job and the second recovery target job as the recovery target descriptor.

Subsequently, the processor may recover the determined at least one recovery target descriptor to the command queue S1460. In an embodiment, the processor may recover the descriptor associated with the first recovery target job prior to recovering the descriptor associated with the second recovery target job, and recover the descriptor associated with the second recovery target job subsequently.

In an embodiment, the processor may obtain at least one descriptor stored in the command queue before being initialized from the tracking data, and recover a descriptor associated with the second recovery target job to the command queue based on the obtained at least one descriptor. In an embodiment, the processor may identify at least one command buffer associated with the command queue before being initialized based on the tracking data, and recover a descriptor associated with the second recovery target job to the command queue based on a command stored in the identified at least one command buffer.

When the initialized command queue is recovered or the initialization command is not received, the processor may determine whether a descriptor associated with a job not yet executed exists S1470. That is, the processor may determine whether the descriptor associated with the unexecuted job is stored in the command queue.

In an embodiment, when completing an artificial intelligence operation associated with at least one descriptor, the processor may delete the descriptor associated with this operation result from the tracking data. Additionally or alternatively, in response to receiving a tracking data deletion command from the host system, the processor may delete a buffer descriptor and/or an address of a command buffer included in the tracking data deletion command from the tracking data.

If it is determined that the descriptor associated with the unexecuted job exists, the processor may determine the job associated with the descriptor of the next order as the target job S1480. Subsequently, the processor may proceed again with step S910 for extracting the descriptor associated with the determined target job (i.e., the descriptor having the highest priority) from the command queue.

On the other hand, when determining that the descriptor associated with the unexecuted job does not exist, the processor may switch to a standby mode and end the method according to FIG. 14. If a new descriptor is stored in the command queue, the processor may restart the method according to FIG. 14.

The flowchart and description described above using FIG. 14 are only an example, and may be implemented differently in some embodiments. For example, in some embodiments, an order of each step may be changed, some steps may be repeatedly performed, some steps may be omitted, or some steps may be added.

The above-described method may be provided as a computer program stored in a computer-readable recording medium for execution on a computer. The medium may be one that continuously stores a program executable by a computer, or temporarily stores it for execution or download. Also, the medium may be various recording means or storage means in a form in which single or several hardware are combined, and is not limited to a medium directly connected to a certain computer system, but may be distributed on a network. Examples of the medium may include magnetic media such as hard disks, floppy disks, and magnetic tapes, optical recording media such as CD-ROMs and DVDs, magneto-optical media such as floptical disks, and media configured to store program instructions, including ROM, RAM, flash memory, and the like. Also, as an example of other media, there may be recording media or storage media managed by an app store distributing applications, a site supplying or distributing other various software, a server, and the like.

The methods, operations, or techniques of the present disclosure may be implemented by various means. For example, these techniques may be implemented in hardware, firmware, software, or a combination thereof. Those skilled in the art will understand that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

In a hardware implementation, processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, the various illustrative logical blocks, modules, and circuits described in connection with the present disclosure may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device, and the like. The instructions may be executable by one or more processors and may cause the processor(s) to perform certain aspects of the functionality described in the present disclosure.

When implemented in software, the above-described techniques may be stored on a computer-readable medium as one or more instructions or code, or transmitted via a computer-readable medium. Computer-readable media include both computer storage media and communication media including any medium that facilitates transfer of a computer program from one place to another. Storage media may be any available media that can be accessed by a computer. By way of non-limiting example, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, server, or other remote source using coaxial cable, fiber optic cable, twisted pair, digital subscriber line (DSL), or wireless technologies such as infrared, radio, and microwave, then the coaxial cable, fiber optic cable, twisted pair, digital subscriber line, or wireless technologies such as infrared, radio, and microwave are included in the definition of medium. Disk and disc, as used herein, includes CD, laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of known storage medium. An exemplary storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in the user terminal.

Although the embodiments described above have been described as utilizing aspects of the presently disclosed subject matter in one or more standalone computer systems, the present disclosure is not limited thereto, and may be implemented in conjunction with any computing environment such as a network or distributed computing environment. Furthermore, aspects of the subject matter in the present disclosure may be implemented in a plurality of processing chips or devices, and storage may be similarly effected across a plurality of devices. Such devices may include PCs, network servers, and portable devices.

Although the present disclosure has been described in connection with some embodiments herein, various modifications and changes can be made without departing from the scope of the present disclosure that can be understood by those skilled in the art to which the present disclosure pertains. Also, such modifications and changes should be considered to fall within the scope of the claims appended hereto.

What is claimed is:

1. A method for managing jobs, performed by at least one processor, comprising:
distributing a plurality of jobs associated with at least one context to a plurality of processing devices, wherein the plurality of processing devices comprise a plurality of command queues storing the distributed jobs;
storing a fully processed job among the distributed jobs in a job pending queue;
identifying a first context associated with an error in response to determining that the error has occurred in the at least one context;
initializing each of the plurality of command queues included in the plurality of processing devices;
determining a recovery target job based on the identified first context; and
recovering the determined recovery target job to each of the plurality of initialized command queues.

2. The method for managing jobs as claimed in claim 1, wherein the determining comprises:
identifying, as a first recovery target job, a job other than the first context among jobs stored in the job pending queue; and
determining, as a second recovery target job, a job other than the first context among jobs stored in each of the plurality of command queues.

3. The method for managing jobs as claimed in claim 2, wherein the recovering comprises:
recovering the first recovery target job prior to recovering the second recovery target job; and
sequentially recovering the second recovery target job to have an order subsequent to the first recovery target job.

4. The method for managing jobs as claimed in claim 3, wherein the job stored in the job pending queue includes node data associated with at least one processing device among the plurality of processing devices, and
wherein the recovering the first recovery target job comprises transmitting the first recovery target job to a processing device associated with the first recovery target job based on the node data included in the first recovery target job.

5. The method for managing jobs as claimed in claim 1, further comprising, after the storing:
identifying a fully processed second context among the at least one context; and
deleting a job associated with the identified second context from the job pending queue.

6. The method for managing jobs as claimed in claim 5, wherein the second context includes a first job and a second job, and
wherein the identifying the fully processed second context comprises:
determining whether the first job is fully processed;
determining whether the second job is fully processed; and
determining that the second context is fully processed in response to determining that the first job and the second job are fully processed.

7. The method for managing jobs as claimed in claim 5, wherein the identifying the second context comprises:
identifying a number of jobs associated with the second context;
counting a completion count of the job associated with the second context; and
determining that the second context is fully processed in response to determining that the counted completion count is equal to the number of jobs.

8. The method for managing jobs as claimed in claim 1, further comprising, prior to the identifying the first context:
receiving an error message from at least one processing device among the plurality of processing devices; and
determining that the error has occurred in the at least one context in response to receiving the error message.

9. The method for managing jobs as claimed in claim 8, wherein the identifying the first context comprises:
identifying a job in which the error has occurred based on the error message; and
determining that the error has occurred in the first context in response to determining that the first context is associated with the job in which the error has occurred.

10. The method for managing jobs as claimed in claim 1, further comprising, prior to the identifying the first context:
receiving a timeout report from at least one processing device among the plurality of processing devices; and
determining that the error has occurred in the at least one context based on the timeout report.

11. The method for managing jobs as claimed in claim 10, wherein the identifying the first context comprises:
identifying a number of jobs included in the first context;
counting a reception count of the timeout report associated with the first context; and
determining that the error has occurred in the first context in response to determining that the reception count is equal to the number of jobs.

12. The method for managing jobs as claimed in claim 1, wherein the storing in the job pending queue comprises:
receiving a job completion report from at least one processing device among the plurality of processing devices;
identifying a job associated with the job completion report in response to receiving the job completion report;
processing the job associated with the job completion report as fully processed; and
storing the fully processed job in the job pending queue.

13. The method for managing jobs as claimed in claim 1, wherein the storing in the job pending queue comprises:
receiving a timeout report from at least one of the plurality of processing devices;
identifying a job associated with the timeout report in response to receiving the timeout report;
processing the job associated with the timeout report as fully processed; and
storing the fully processed job in the job pending queue.

14. The method for managing jobs as claimed in claim 13, wherein the at least one context is associated with a specific user, and
wherein the method further comprises:
identifying a context associated with the timeout report in response to receiving the timeout report; and
transmitting the timeout report to a user associated with the identified context.

15. The method for managing jobs as claimed in claim 1, wherein the first context includes a third job and a fourth job,
the third job includes a first command and a second command,
the fourth job includes a third command and a fourth command, and
at least one of the first command or the second command is associated with at least one of the third command or the fourth command.

16. A non-transitory computer-readable recording medium storing instructions that, when executed by a processor, cause the processor to perform the method of claim 1.

17. A computing system comprising:
a job pending queue storing a fully processed job; and
at least one host processor configured to manage the job pending queue,
wherein the at least one host processor is further configured to:
distribute a plurality of jobs associated with at least one context to a plurality of processing devices, wherein the plurality of processing devices comprise a plurality of command queues storing the distributed jobs;
store a fully processed job among the distributed jobs in the job pending queue;
identify a first context associated with an error in response to determining that the error has occurred in at least one context;
initialize each of the plurality of command queues included in the plurality of processing devices;
determine a recovery target job based on the identified first context; and
recover the determined recovery target job to each of the plurality of initialized command queues.

18. The computing system as claimed in claim 17, wherein the determining comprises:
identifying, as a first recovery target job, a job other than the first context among jobs stored in the job pending queue; and
determining, as a second recovery target job, a job other than the first context among jobs stored in each of the plurality of command queues.

19. The computing system as claimed in claim 18, wherein the recovering comprises:
recovering the first recovery target job prior to recovering the second recovery target job; and
sequentially recovering the second recovery target job to have an order subsequent to the first recovery target job.

20. The computing system as claimed in claim 17, wherein the at least one host processor is further configured to:
identify a fully processed second context among the at least one context; and
delete a job associated with the identified second context from the job pending queue.
